(19) United States
(12) Patent Application Publication
(10) Pub. No.: US 2002/0079438 A1
(43) Pub. Date: Jun. 27, 2002

(54) Image sensor package and substrate thereof

(76) Inventor: Vincent Lin, Taipei (TW)

Correspondence Address: LOWE HAUPTMAN GOPSTEIN GILMAN & BERNER, LLP, Suite 310, 1700 Diagonal Road, Alexandria, VA, 22314, US

(21) Appl. No.: 09/748,201

(22) Filed: Dec. 27, 2000

(51) Int. Cl. H01J 5/02; H01J 40/14

(52) U.S. Cl. 250/239

(57) ABSTRACT

An image sensor package mainly comprises a main body and an image sensor chip directly attached to a chip-supporting member integrally formed with the main body through an adhesive layer. The image sensor chip is electrically connected to a lead frame integrally formed with the main body. The main body has a wall erected around the image sensor chip with a height taller than the height of the image sensor chip. A optically transparent cover sealed over the top of the wall of the main body thereby allowing the image sensor chip to be exposed to the object to be sensed on an optical principle.

### BACKGROUND OF THE INVENTION

1 Field of the Invention

This invention relates to an image sensor package and more specifically to a substrate for use in forming the image sensor package.

2. Description of the Related Art

In a typical imaging application, in order to protect the image sensing device in the form of an integrated circuit die, i.e., the image sensor chip, from physical damage and from contaminants in the surrounding environment, it is the practice to place the image sensor chip in a package which includes an opening sealed by a transparent lid thereby allowing the image sensor chip to be exposed to the object to be sensed on an optical principle.

In conventional packaging of these devices, the image sensor chip is mounted on a cofired ceramic substrate with protruding pins by means of an adhesive layer. Typically, the adhesive layer must be cured to fixedly attach the image sensor chip to the ceramic substrate. After wire-bonding and window sealing, the pins are cut to proper length to complete the packaging process.

The ceramic package has many advantages such as low moisture permeability, high dimensional stability, a coefficient of thermal expansion (CTE) closely matching silicon and good thermal conductivity. However, the major disadvantage of the ceramic package is the cost. Therefore, the current trend in the packaging industry is shifting from the ceramic substrate-based packages to organic substrate-based packages because the organic substrate based packages are less expensive to process and fabricate.

Normally, the image sensor chip is formed of microcrystalline silicon with a coefficient of thermal expansion (CTE) of about 33×10⁻⁷/°C. However, the organic substrate is usually formed of polymer impregnated fiberglass having a coefficient of thermal expansion of 250×10⁻⁷/°C. −400×10⁻⁷/°C. Since there is a significant difference between the image sensor chip and the organic substrate in CTE, the image sensor chip and the organic substrate expand and contract in different amounts along with temperature fluctuations during the curing process of the adhesive layer. This causes warpage of the image sensor chip and the organic substrate thereby resulting in adverse influences that makes the chip unable to detect image. The higher curing temperature and longer curing time are employed, the greater warpage the image sensor chip and the organic substrate will produce. The warped organic substrate and chip will result in adverse influences on the chip itself and the subsequent manufacturing process. The thermal stress due to CTE mismatch may result in delamination between the chip and the substrate or chip cracking. Also, such differences in CTE could induce undesirable strains in the mechanical and electrical connections between the chip and the substrate

The present invention therefore seeks to provide a substrate for packaging the image sensor chip which overcomes, or at least reduces the above-mentioned problems of the prior art.

### SUMMARY OF THE INVENTION

It is a primary object of the present invention to provide a substrate for packaging an image sensor chip which mainly comprises a flat chip-supporting member embedded in a main body of thermosetting plastic material wherein the chip-supporting member is formed from materials with a CTE matching the CTE of the image sensor chip thereby providing stress relief in the finished package caused by CTE mismatch between the image sensor chip and the main body.

The substrate of the present invention mainly comprises a main body of thermosetting plastic material, a flat chip-supporting member embedded in the main body and a lead frame molded integrally with the main body. The lead frame includes a plurality of conductive leads having inner lead portions adapted for coupling to an image sensor chip and outer lead portions for making external electrical connection. The main body has a wall erected from the periphery thereof with a height taller than the height of the image sensor chip.

In an image sensor package in accordance with the present invention, the image sensor chip is attached to the chip-supporting member integrally formed with the main body through an adhesive layer. The image sensor chip is electrically connected to the inner lead portions of the conductive leads of the lead frame. The image sensor package is provided with a transparent cover sealed over the top of the wall of the main body thereby allowing the image sensor chip to be exposed to the object to be sensed. through the opening.

Since the image sensor chip is directly attached to the chip-supporting member formed from materials with a CTE matching the CTE of the image sensor chip, the image sensor chip and the chip-supporting member expand and contract in substantially the same amount along with temperature fluctuations. Therefore, the chip-supporting member embedded in the main body provides stress relief in the package caused by CTE mismatch between the image sensor chip and the main body thereby significantly reducing the above-mentioned problems of the prior art.

### BRIEF DESCRIPTION OF THE DRAWINGS

Other objects, advantages, and novel features of the invention will become more apparent from the following detailed description when taken in conjunction with the accompanying drawings.

FIG. 1 is a sectional view of a substrate for use in forming an image sensor package according to a first preferred embodiment of the present invention;

FIG. 2 is a sectional view of a substrate for use in forming an image sensor package according to a second preferred embodiment of the present invention;

FIG. 3 is a top plan view of a substrate for use in forming an image sensor package according to a preferred embodiment of the present invention;

FIG. 4 is a sectional view of an image sensor package according to a first preferred embodiment of the present invention;

FIG. 5 is a sectional view of an image sensor package according to a second preferred embodiment of the present invention;

FIG. 6 is a sectional view of a substrate for use in forming an image sensor package according to a third preferred embodiment of the present invention;

FIG. 7 is a sectional view of a substrate for use in forming an image sensor package according to a fourth preferred embodiment of the present invention;

FIG. 8 is a sectional view of a substrate for use in forming an image sensor package according to a fifth preferred embodiment of the present invention; and

FIG. 9 is a sectional view of a substrate for use in forming an image sensor package according to a sixth preferred embodiment of the present invention.

### DETAILED DESCRIPTION OF THE PREFERRED EMBODIMENT

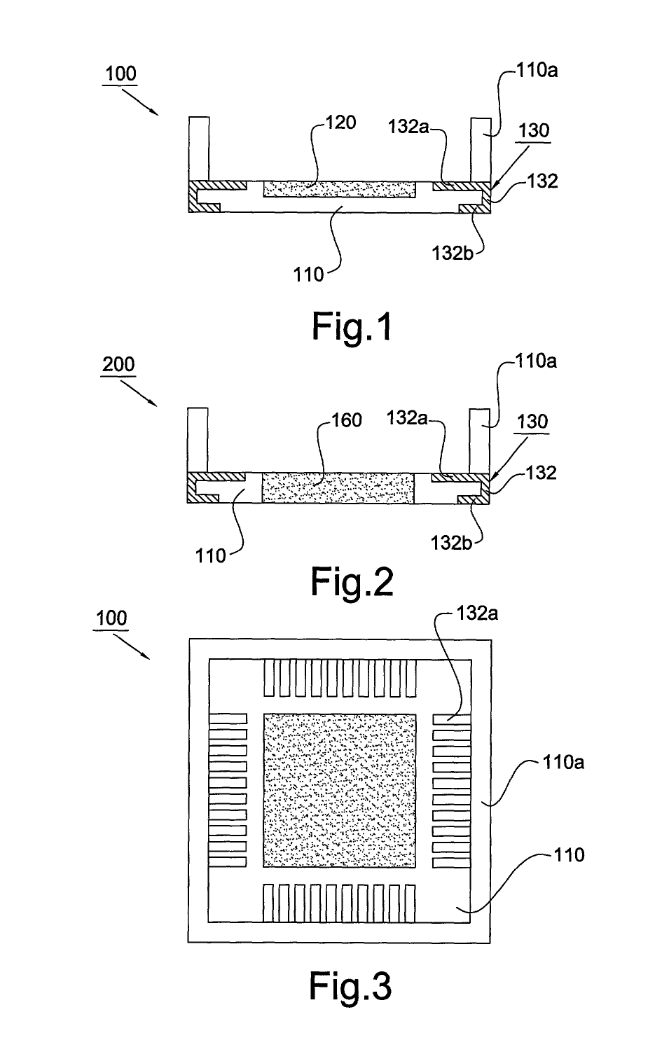

FIG. 1 and FIG. 3 shows a substrate 100 for use in forming an image sensor package according to a first preferred embodiment of the present invention. The substrate 100 mainly comprises a main body 110 of thermosetting plastic material, a flat chip-supporting member 120 embedded in the main body 110 and a lead frame 130 molded integrally with the main body. The lead frame 130 includes a plurality of conductive leads 132 having inner lead portions 132a adapted for coupling to an image sensor chip (not shown) and outer lead portions 132b for making external electrical connection. The main body 110 has a wall 110a erected from the periphery thereof with a height taller than the height of the image sensor chip. It is noted that, as shown in the FIG. 3, the upper surface of the chip-supporting member 120 is directly exposed from the upper surface of the main body 110 for receiving the image sensor chip (not shown). FIG. 2 shows a substrate 200 for use in forming an image sensor package according to a second preferred embodiment of the present invention. In the substrate 200, the chip-supporting member 160 has a thickness substantially the same as the thickness of the main body 110 whereby the chip-supporting member 160 is exposed from the upper as well as the lower surface of the main body 110 thereby enhancing the thermal performance.

Preferably, the substrate of the present invention is formed by a conventional molding process such as insert molding. This is accomplished by placing the chip-supporting member and the lead frame in a mold having cavities and thereafter pouring thermosetting plastic material into the mold to fill the mold cavities. The mold cavities are shaped to substantially conform to the to-be-molded shape of the substrate. Finally, the molded product is placed into a curing oven, and then the plastic material is cured wherein the curing condition depends on the selected plastic material. Preferably, the thermosetting plastic material is selected from heat-resistant thermosetting engineering plastics in view of easiness to process, short shaping time and low cost whereby the manufacturing cost of the substrate of the present invention can be significantly reduced. The lead frame in accordance with the present invention is formed from a thin metal strip which has been etched or stamped to form the conductive leads. Preferably, the lead frame is made of copper or alloys containing copper. Alternatively, the lead frame is made of iron, nickel or alloys thereof, and then plated with copper. Preferably, the chip-supporting member is formed from materials with a CTE matching the CTE of the image sensor chip and has a hardness sufficient to provide good flatness. Furthermore, the chip-supporting member must have a good thermal conductivity for enhancing the thermal performance of the finished package. Preferably, the chip-supporting member has a coefficient of thermal expansion (CTE) ranging from about 20×10⁻⁷/°C. to about 100×10⁻⁷/°C. and a thermal conductivity ranging from about 10 W/m.K to about 600 W/m.K. Suitable materials for use in forming the chip-supporting member are ceramic materials, alumina (Al₂O₃) and glass materials (such as borosilicate glass).

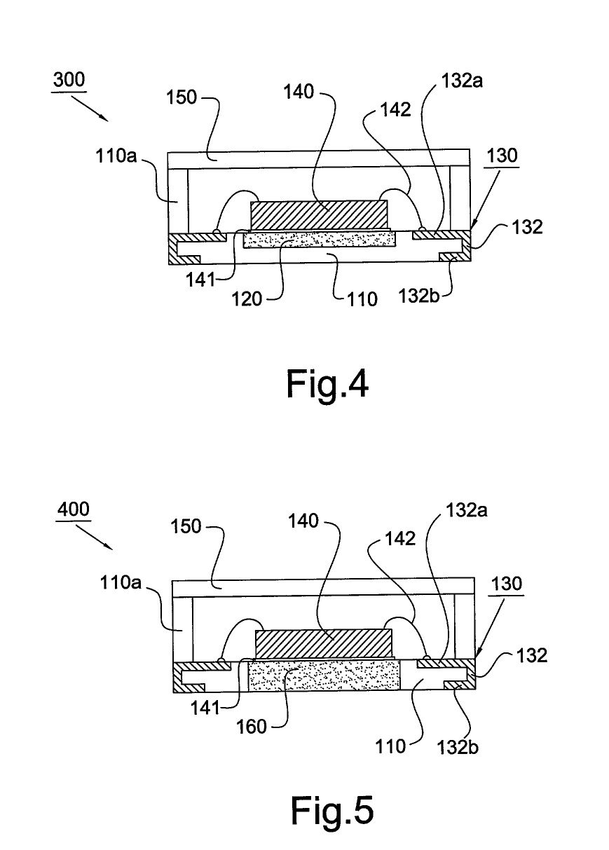

FIG. 4 shows an image sensor package 300 using the substrate 100 of FIG. 1 of the present invention. The image sensor chip 140 is attached to the chip-supporting member 120 integrally formed with the main body 110 by means of an adhesive layer such as a silver-filled epoxy 141. Alternatively, the adhesive layer may be a non-conductive adhesive. The image sensor chip 140 is electrically connected to the inner lead portions 132a of the conductive leads 132 of the lead frame 130 through a plurality of bonding wires such as gold wires 142. The image sensor package is provided with a transparent cover 150 sealed over the top of the wall 110a of the main body 110 thereby allowing the image sensor chip 140 to be exposed to the object to be sensed (not shown). Preferably, the transparent cover 150 is an optically plastic lid or glass lid of high transparency.

FIG. 5 shows an image sensor package 400 using the substrate 200 of FIG. 2 of the present invention. The package 400 is characterized in that the lower surface of the chip-supporting member is exposed from the lower surface of the main body 110 for enhancing the heat-dissipation of the image sensor chip 140.

The image sensor packages 300, 400 in accordance with the present invention can be mounted onto a printed circuit board, like other leadless devices. For example, the printed circuit board is screened printed with a solder paste in a pattern which corresponds to the pattern of the outer lead portions 132b exposed from the bottom surface of the packages 300, 400. The package is then appropriately positioned on the printed circuit board and the solder is reflowed. It should be understood that the outer lead portions 132b of the leads exposed from the bottom surface of the packages can be printed with solder paste and then mounted onto a printed circuit board.

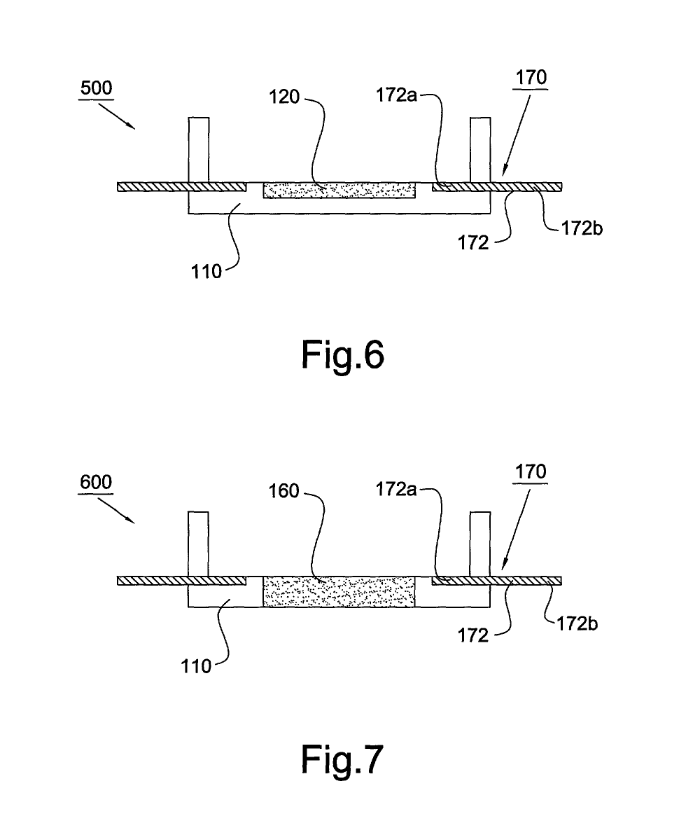

Referring to FIG. 6 and FIG. 7, the conductive leads 172 of the lead frame 170 can be trimmed such that parts of them still extend outwardly of the main body 110, which, in turn, are formed into standard lead configurations such as gull-wing, J-lead or the like.

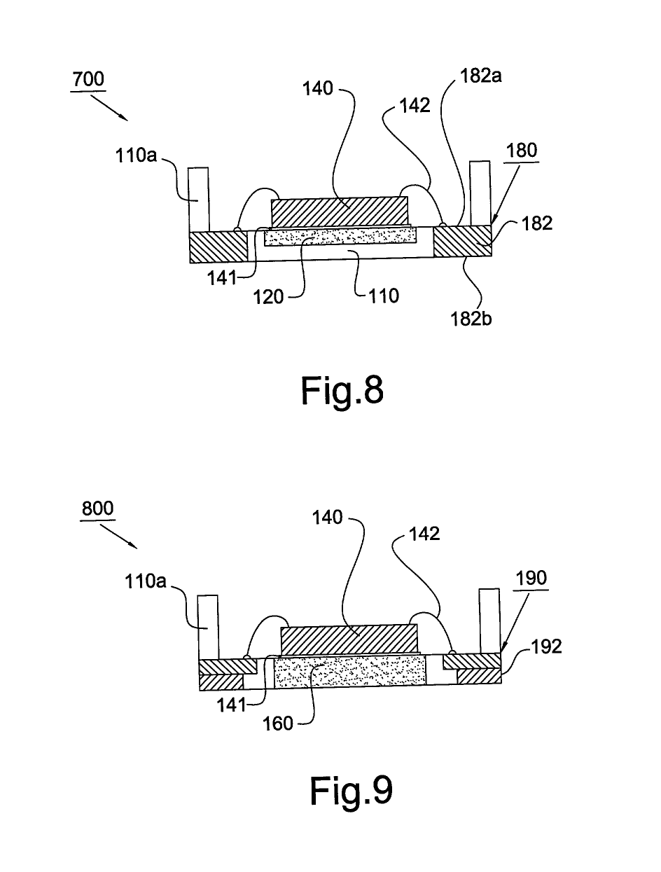

FIG. 8 shows a substrate 700 for use in forming an image sensor package according to a fifth preferred embodiment of the present invention. The substrate 700 is characterized by using a flat-type lead frame 180. The lead frame 180 includes a plurality of flat-type conductive leads 182. The flat-type lead frame 180 has advantages in that, after inject molding of the substrate, the forming step of the leads 182 is omitted thereby significantly reducing the problem of flatness after forming.

FIG. 9 shows a substrate 800 for use in forming an image sensor package according to a fifth preferred embodiment of the present invention. The substrate 800 is characterized in that the conductive leads 192 of the lead frame 190 can be disassembled into two pieces or more if required.

In the image sensor package of the present invention, since the image sensor chip is directly attached to the chip-supporting member formed from materials with a CTE matching the CTE of the image sensor chip, the image sensor chip and the chip-supporting member expand and contract in substantially the same amount along with temperature fluctuations. Therefore, the chip-supporting member embedded in the main body provides stress relief in the package caused by CTE mismatch between the image sensor chip and the main body thereby significantly reducing the above-mentioned problems of the prior art.

Although the invention has been explained in relation to its preferred embodiment, it is to be understood that many other possible modifications and variations can be made without departing from the spirit and scope of the invention as hereinafter claimed.

What is claimed is:

1. An image sensor package comprising:
a main body of thermosetting plastic material;
a flat chip-supporting member embedded in the main body;
an image sensor chip attached to the chip-supporting member through an adhesive layer;
a wall erected around the image sensor chip with a height taller than the height of the image sensor chip; and
a lead frame molded integrally with the main body, the lead frame including a plurality of conductive leads having inner lead portions for coupling to the image sensor chip and outer lead portions for making external electrical connection; and
a transparent cover sealed over the top of said wall.

2. The image sensor package as claimed in claim 1, wherein the chip-supporting member has a coefficient of thermal expansion (CTE) ranging from about 20×10⁻⁷/°C. to about 100×10⁻⁷/°C. and a thermal conductivity ranging from about 10 W/m.K to about 600 W/m.K.

3. The image sensor package as claimed in claim 2, wherein the chip-supporting member is formed of ceramic materials.

4. The image sensor package as claimed in claim 2, wherein the chip-supporting member is made of alumina (Al₂O₃).

5. The image sensor package as claimed in claim 2, wherein the chip-supporting member is formed of glass materials.

6. The image sensor package as claimed in claim 1, wherein the main body has opposing upper and lower surfaces and the chip-supporting member is exposed from the upper surface of the main body.

7. The image sensor package as claimed in claim 6, wherein the chip-supporting member is exposed from both surfaces of the main body.

8. A substrate for use in forming an image sensor package comprising:
a main body of thermosetting plastic material;
a flat chip-supporting member embedded in the main body and adapted for receiving an image sensor chip;
a wall erected from the periphery of the main body with a height taller than the height of the image sensor chip; and
a lead frame molded integrally with the main body, the lead frame including a plurality of conductive leads having inner lead portions adapted for coupling to the image sensor chip and outer lead portions for making external electrical connection.

9. The substrate as claimed in claim 8, wherein the chip-supporting member has a coefficient of thermal expansion (CTE) ranging from about 20×10⁻⁷/°C. to about 100×10⁻⁷/°C. and a thermal conductivity ranging from about 10 W/m.K to about 600 W/m.K.

10. The substrate as claimed in claim 9, wherein the chip-supporting member is formed of ceramic materials.

11. The substrate as claimed in claim 9, wherein the chip-supporting member is made of alumina (Al₂O₃).

12. The substrate as claimed in claim 9, wherein the chip-supporting member is formed of glass materials.

13. The substrate as claimed in claim 8, wherein the main body has opposing upper and lower surfaces and the chip-supporting member is exposed from the upper surface of the main body.

14. The substrate as claimed in claim 13, wherein the chip-supporting member is exposed from both surfaces of the main body.
